(19) United States
(12) Patent Application Publication
(10) Pub. No.: US 2010/0181749 A1
(43) Pub. Date: Jul. 22, 2010

(54) Side airbag and side airbag device

(75) Inventor: Shinichi Sugimoto, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TK HOLDINGS INC., Greensboro, NC (US)

(21) Appl. No.: 12/656,118

(22) Filed: Jan. 19, 2010

(30) Foreign Application Priority Data
Jan. 19, 2009 (JP) 2009-009320

(51) Int. Cl. B60R 21/16

(52) U.S. Cl. 280/743.2

(57) ABSTRACT

A side airbag is formed by a first panel portion facing an occupant and a second panel portion facing a side opposite the occupant and connected to the first panel portion. The side airbag is inflated and deployed on a side of the occupant, and includes an upper chamber for receiving at least a breast of the occupant, a lower chamber for receiving a hip of the occupant, and a first tether having a first edge portion connected to the first panel portion and a second edge portion connected to the second panel portion. The first tether separates the upper chamber and the lower chamber such that connected positions of the first edge portion and the second edge portion are offset from each other. A cylindrical inflating portion defined by the first tether is provided on a rear side in the lower chamber in a vehicle front-rear direction.

### BACKGROUND OF THE INVENTION AND RELATED ART STATEMENT

The present invention relates to a side airbag and a side airbag device that receives an occupant, for example, in case of a side collision of a vehicle such as an automobile.

There is known a side airbag device in which a side airbag is inflated on a side of an occupant by an inflator so as to receive the body of the occupant, for example, in case of a side collision of a vehicle, such as an automobile, or a rollover of the vehicle. The side airbag device is stored in a seat back of the seat as an example. In case of a side collision or the like, the side airbag is inflated and deployed from the seat back between the occupant and a side wall of the vehicle by gas discharged from the inflator.

A known side airbag of such a type includes an upper chamber for receiving at least the breast of the occupant and a lower chamber for receiving the hip (for example, see Patent Document 1). In this side airbag, safety of the occupant is enhanced by setting the internal pressure of the upper chamber for receiving the breast, which is susceptible to external shock, to be lower than the internal pressure of the lower chamber for receiving the hip.

Patent Document 1: Japanese Unexamined Patent Application Publication No. 2006-62566

The above-described related art discloses the basic configuration of the side airbag device in which the internal pressure of the upper chamber is set to be lower than that of the lower chamber.

To optimize the side airbag device having this configuration, it is required to enhance deployment stability by suppressing rattling of the lower chamber during inflation and deployment because of the difference in internal pressure between the upper chamber and the lower chamber.

An object of the present invention is to provide a side airbag and a side airbag device that can enhance deployment stability by suppressing rattling of a lower chamber during inflation and deployment.

Further objects and advantages of the invention will be apparent from the following description of the invention.

### SUMMARY OF THE INVENTION

To achieve the above object, a side airbag according to a first aspect of the invention is formed by a first panel portion facing an occupant to be restrained and a second panel portion facing a side opposite the occupant, and inflates and deploys on a side of the occupant. The side airbag includes an upper chamber configured to receive at least the breast of the occupant; a lower chamber configured to receive the hip of the occupant; a first tether having a first edge portion connected to the first panel portion and a second edge portion connected to the second panel portion, the first tether being connected to separate the upper chamber and the lower chamber in a manner such that connected positions of the first edge portion and the second edge portion are offset from each other; and a cylindrical inflating portion provided on a rear side in the lower chamber in a vehicle front-rear direction, the cylindrical inflating portion being formed by the first tether so as to become cylindrical when inflated.

For example, the side airbag is stored in a folded state in a seat back of a seat, and is inflated and deployed between the occupant and a side wall of the vehicle by gas discharged from an inflator in case of a side collision of the vehicle or a rollover of the vehicle. In this case, for example, the flow rate of gas supplied from the inflator to the upper chamber for receiving the breast of the occupant, which is susceptible to external shock, and the lower chamber for receiving the hip is adjusted so that the internal pressure of the upper chamber is lower than the internal pressure of the lower chamber.

Here, in the side airbag including the upper chamber and the lower chamber, in general, gas discharging ports of the inflator are located near the rear end in the vehicle front-rear direction of the first tether serving as a line that separates the two chambers. This aims to smoothly supply the gas from the gas discharging ports to the upper chamber and the lower chamber. For this reason, if both edges of the first tether are not offset, the length of the cylindrical inflating portion located on the rear side in the lower chamber is substantially equal to the length from a lower end of the airbag to the portion adjacent to the gas discharging ports.

In this case, in the first aspect of the present invention, the first tether that separates the upper chamber and the lower chamber is connected in a manner such that the connected position of the first edge portion to the first panel portion and the connected position of the second edge portion to the second panel portion are offset from each other. When a lower region of the first tether is caused to correspond to the gas discharging ports of the inflator with such an offset structure of the first tether, the length of the cylindrical inflating portion can be made larger than the above-described length (length from the lower end of the airbag to the adjacencies of the gas discharging ports) by a higher region. Hence, rigidity of the lower chamber can be increased by the cylindrical inflating portion having the increased length. As a result, it is possible to suppress rattling of the lower chamber during inflation and deployment because of the difference in internal pressure between the upper chamber and the lower chamber, and to thereby enhance deployment stability of the side airbag.

According to the first aspect of the invention, the following advantages can also be obtained. That is, for example, in case that the connected positions of the first edge portion and the second edge portion of the first tether are not offset, when the length of the cylindrical inflating portion is to be increased for stability of the lower chamber, the rear end of the first tether needs to be located at a position as high as possible in the airbag. As a result, the inflator also needs to be mounted at a high position. In contrast, when it is impossible to mount the inflator at a high position, for example, because of the specifications of a seat frame, the rear end of the first tether needs to be at a low position. As a result, the length of the cylindrical inflating portion is shortened, and stability of the low chamber becomes insufficient. Therefore, to stabilize the lower chamber, the mounting position of the inflator is limited to the upper part of the airbag. In this case, since the first tether has the offset structure in the first invention of the present application, when the lower region of the first tether is located corresponding to the gas discharging ports of the inflator, as described above, a required length of the cylindrical inflating portion can be ensured by the higher region. Thus, even when the mounting position of the inflator is low, the lower chamber can be stabilized. It is therefore possible to increase the flexibility in the mounting position of the inflator.

In a side airbag of a second aspect of the invention, according to the above first aspect, a lower region of the first tether is provided with an insertion portion in which an inflator that supplies gas for inflating the side airbag is inserted.

Therefore, the length of the cylindrical inflating portion can be made greater than the above-described length provided when the offset structure is not adopted (length from the lower end of the airbag to the position adjacent to the gas discharging ports) by the higher region of the first tether. Hence, rigidity of the lower chamber can be increased by the cylindrical inflating portion having the increased length. As a result, it is possible to suppress rattling of the lower chamber during inflation and deployment, and to thereby enhance deployment stability of the side airbag.

In a side airbag of a third aspect, according to the above first or second aspect, the first tether is connected to the first panel portion and the second panel portion in an offset manner such that the connected position of the first edge portion to the first panel portion is lower than the connected position of the second edge portion to the second panel portion.

In the third aspect of the present invention, the first tether is connected to the first panel portion and the second panel portion in a manner such that the connected position of the first edge portion to the first panel portion is lower than the connected position of the second edge portion to the second panel portion. That is, the first tether is connected to the panel portions in a manner such that the connected position on the occupant side is lower than the connected position on the side opposite the occupant (on the side of the side wall of the vehicle). With this structure, the size of the lower chamber on the side of the first panel portion close to the occupant can be smaller than the size of the lower chamber on the side of the second panel portion close to the side wall of the vehicle. Thus, it is possible to prevent the lower chamber, which has a pressure higher than that of the upper chamber, from contacting the body of the occupant more than necessary, for example, in case of a side collision of the vehicle or a rollover of the vehicle, and to thereby enhance safety of the occupant.

In a side airbag of a fourth aspect, according to any of the above first to third aspects, an offset amount between the connected position of the first edge portion and the connected position of the second edge portion is substantially equal to a width of the first tether.

Hence, when the side airbag in an uninflated state is placed in a planar form such that one of the first panel portion and the second panel portion is placed on the other in the up-down direction, the first tether can be made planar without forming a fold and a wrinkle. As a result, since the side airbag can be flat, it can be easily folded for storage, and can be prevented from becoming bulky. Further, when the side airbag is placed in a planar form, the first tether also becomes planar, and it is therefore possible to enhance operability in connecting (sewing) the first tether to the first panel portion and the second panel portion during production.

A side airbag of a fifth aspect, according to any of the above first to fourth aspects, further includes a second tether configured to separate the upper chamber into a first chamber for receiving the shoulder of the occupant and a second chamber for receiving the breast of the occupant.

In the fifth aspect of the present invention, the side airbag has a three-chamber structure including the first chamber for receiving the shoulder of the occupant, the second chamber for receiving the breast of the occupant, and the lower chamber for receiving the hip of the occupant. By thus forming multiple chambers for receiving the parts of the body of the occupant, the chambers can receive the body parts in fine response to the characteristics thereof. This further enhances safety of the occupant.

In a side airbag of a sixth aspect, according to the above fifth aspect, the second tether includes a third edge portion connected to the first panel portion and a fourth edge portion connected to the second panel portion, and is connected to the first panel portion and the second panel portion in an offset manner such that a connected position of the third edge portion to the first panel portion is higher than a connected position of the fourth edge portion to the second panel portion at least in a certain region.

In general, in the side airbag including the first chamber for receiving the shoulder of the occupant and the second chamber for receiving the breast of the occupant, the internal pressure of the second chamber for receiving the breast, which is susceptible to external shock, is set to be lower than the internal pressure of the first chamber for receiving the shoulder.

In the sixth aspect of the present invention, the second tether is connected to the first panel portion and the second panel portion in a manner such that the connected position of the third edge portion to the first panel portion is higher than the connected position of the fourth edge portion to the second panel portion at least in a certain region. That is, the second tether is connected to the panel portion in a manner such that the connected position on the occupant side is higher than the connected position on the side opposite the occupant (on the side of the side wall of the vehicle) at least in a certain region. With this, the size of the first chamber on the side of the first panel portion close to the occupant can be smaller than the size of the first chamber on the side of the second panel portion close to the side wall of the vehicle. Thus, it is possible to prevent the first chamber, which has a pressure higher than that of the second chamber, from contacting the body of the occupant more than necessary, for example, in case of a side collision of the vehicle or a rollover of the vehicle body, and to thereby enhance safety of the occupant.

In a side airbag of a seventh aspect, according to the above fifth or sixth aspect, an offset amount between the connected position of the third edge portion and the connected position of the fourth edge portion is substantially equal to a width of the second tether.

Hence, when the side airbag in an uninflated state is placed in a planar form such that one of the first panel portion and the second panel portion is placed on the other in the up-down direction, not only the first tether, but also the second tether can be made planar without forming a fold and a wrinkle. As a result, even when the side airbag has three chambers, it can be made flat. Therefore, the side airbag can be easily folded for storage and does not become bulky. In addition, it is possible to enhance operability in connecting (sewing) the second tether to the first panel portion and the second panel portion during production.

To achieve the above objects, a side airbag device of an eight aspect includes the side airbag according to any of the above first to seventh aspects, an inflator provided on a rear side in the side airbag in the vehicle front-rear direction, the inflator supplying gas for inflating and deploying the side airbag, and a casing configured to store the side airbag and the inflator.

For example, the side airbag device is stored in a folded state in a seat back of a seat, and the side airbag is inflated and deployed between the occupant and the side wall of the vehicle by gas discharged from the inflator in case of a side collision of the vehicle or a rollover of the vehicle body. In this case, for example, the flow rate of gas supplied from the inflator to the upper chamber for receiving the breast of the occupant that is susceptible to external shock and the lower chamber for receiving the hip is adjusted so that the internal pressure of the upper chamber is lower than the internal pressure of the lower chamber.

In the side airbag including the upper chamber and the lower chamber, in general, gas discharging ports of the inflator are located near the rear end in the vehicle front-rear direction of the first tether serving as a line that separates the two chambers. This aims to smoothly supply the gas from the gas discharging ports to the upper chamber and the lower chamber. For this reason, if both edges of the first tether are not offset, the length of the cylindrical inflating portion located on the rear side in the lower chamber is substantially equal to the length from the lower end of the airbag to the portion adjacent to the gas discharging ports.

In this case, in the eighth aspect of the present invention, the first tether for separating the upper chamber and the lower chamber in the side airbag is connected in a manner such that the connected position of the first edge portion to the first panel portion and the connected position of the second edge portion to the second panel portion are offset from each other. When a lower region of the first tether is caused to correspond to the gas discharging ports of the inflator with such an offset structure of the first tether, the length of the cylindrical inflating portion can be made greater than the above-described length (length from the lower end of the airbag to the portion adjacent the gas discharging holes) by a higher region. Hence, rigidity of the lower chamber can be increased by the cylindrical inflating portion having the increased length. As a result, it is possible to suppress rattling of the lower chamber during inflation and deployment because of the difference in internal pressure between the upper chamber and the lower chamber, and to thereby enhance deployment stability of the side airbag.

According to the present invention, it is possible to enhance deployment stability of the side airbag by suppressing rattling of the lower chamber during inflation and deployment.

### BRIEF DESCRIPTION OF THE DRAWINGS

FIGS. 1(a) and 1(b) are schematic side views showing a seat of an automobile equipped with a side airbag device according to a first embodiment of the present invention in a normal state and in a state in which a side airbag is inflated.

FIG. 2 is a side view showing an overall configuration of the side airbag in an inflated and deployed state.

FIG. 3 is a plan view of the side airbag in an uninflated state, as viewed from a second panel.

FIG. 4 is a plan view of the side airbag in the uninflated state, as viewed from a first panel.

FIGS. 5(a) and 5(b) are schematic cross-sectional views of the side airbag, wherein FIG. 5(a) is a vie taken along line 5(a)-5(a) of FIG. 3, and FIG. 5(b) is a view showing an inflated state of the side airbag.

FIG. 6 is a plan view showing a state in which a first tether is attached to the first panel, in order to show a structure of an insertion portion for the first tether.

FIG. 7 is an enlarged partial view showing a state in which an inflator is inserted in the insertion portion.

FIGS. 8(a)-8(c) are views illustrating a procedure for forming the first tether.

FIG. 9 is a conceptual cross-sectional view (taken along line 9-9 in FIG. 3) of the side airbag in an inflated state, in order to explain that the inflator is inserted in a lower region of the first tether by the insertion portion for the first tether.

FIG. 10 is a perspective view showing an overall structure of a sleeve provided in the inflator.

FIG. 11 is a side view showing an overall configuration of a side airbag in an inflated and deployed state according to a second embodiment.

FIG. 12 is a plan view of the side airbag in an uninflated state, as viewed from a second panel.

FIG. 13 is a plan view of the side airbag in the uninflated state, as viewed from a first panel.

FIGS. 14(a) and 14(b) are a schematic cross-sectional views of the side airbag, wherein FIG. 14(a) is a view taken along line 14(a)-14(a) in FIG. 12, and FIG. 14(b) is a view showing an inflated state of the side airbag.

### DETAILED DESCRIPTION OF PREFERRED EMBODIMENTS

A first embodiment of the present invention will be described below with reference to the drawings. In the following description, the term “vehicle front-rear direction” refers to a front-rear direction of a vehicle, as viewed from a sitting occupant 12.

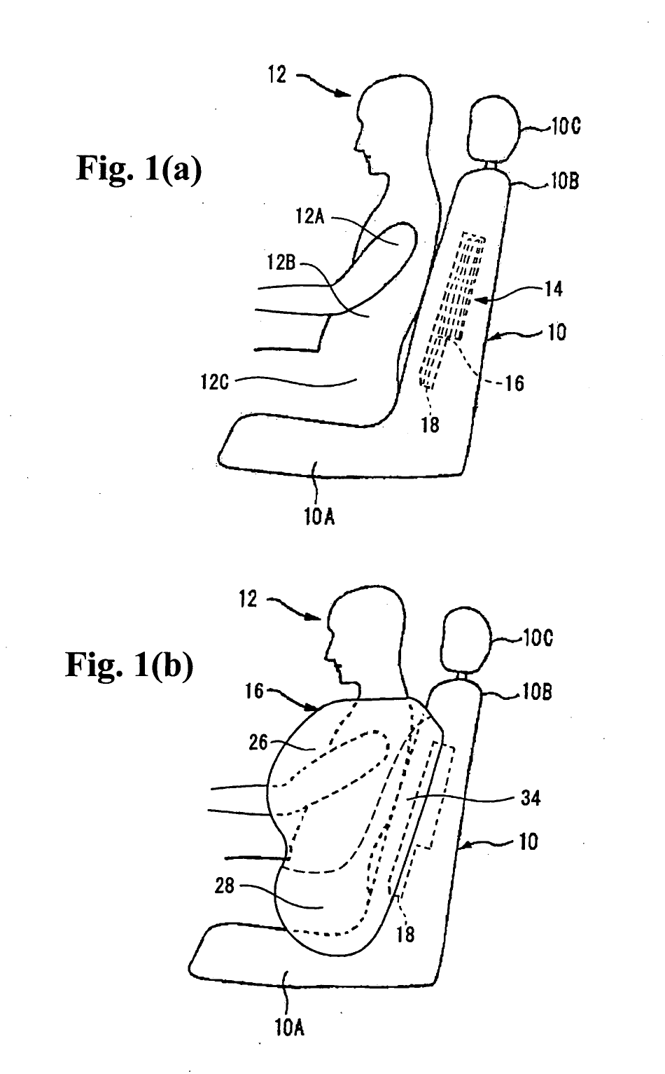

FIGS. 1(a) and 1(b) are schematic side views of a seat of an automobile equipped with a side airbag device according to an embodiment of the present invention. FIG. 1(a) shows a normal state, and FIG. 1(b) shows an inflated state of a side airbag.

In FIGS. 1(a) and 1(b), the occupant 12 is sitting on a seat 10. The seat 10 includes a seat portion 10A. A seat back 10B protrudes upward from the seat portion 10A. A headrest 100 is attached to the top of the seat back 10B.

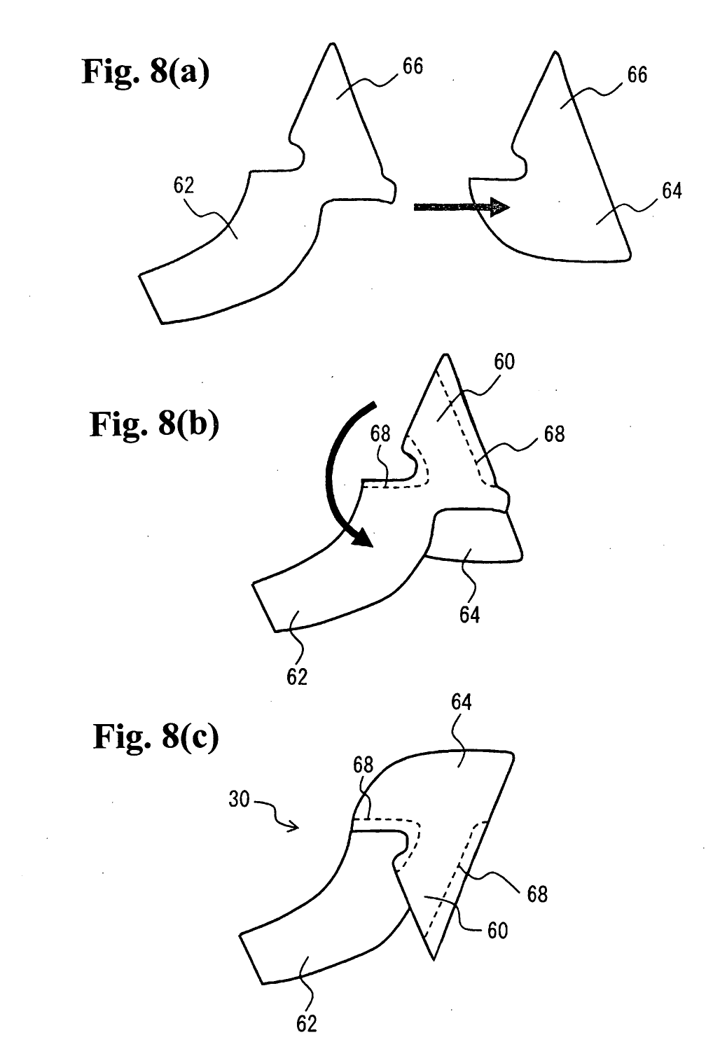

The seat 10 has, in the seat back 10B, a side airbag device 14 that receives the upper body of the occupant 12, for example, in case of a side collision or a rollover of the vehicle due to an accident. The side airbag device 14 includes a side airbag that inflates and deploys between a side wall (not shown, located on the near side of the plane of FIGS. 1(a) and 1(b)) of the body of the automobile and the occupant 12 sitting on the seat 10, a casing 18 in which the side airbag 16 is stored in a folded state and which is formed of, for example, resin or nonwoven fabric, and a substantially cylindrical inflator 20 that supplies gas for inflating and deploying the side airbag 16 (see below-mentioned FIG. 8 and so on). The inflator 20 is ignited by an inflator control circuit that is not shown.

As shown in FIG. 1(a), in a normal state, the side airbag 16 is stored in the seat back 10B of the seat 10 while being folded in the casing 18. For example, when the automobile encounters a side collision, the inflator 20 of the side airbag device 14 is ignited by the inflator control circuit (not shown), and the side airbag 16 inflates, comes out of the seat 10 (through an unshown seam line on a cloth of a side face of the seat back 10B in this embodiment), and deploys between the side wall of the body of the automobile and the occupant 12, as shown in FIG. 1(b).

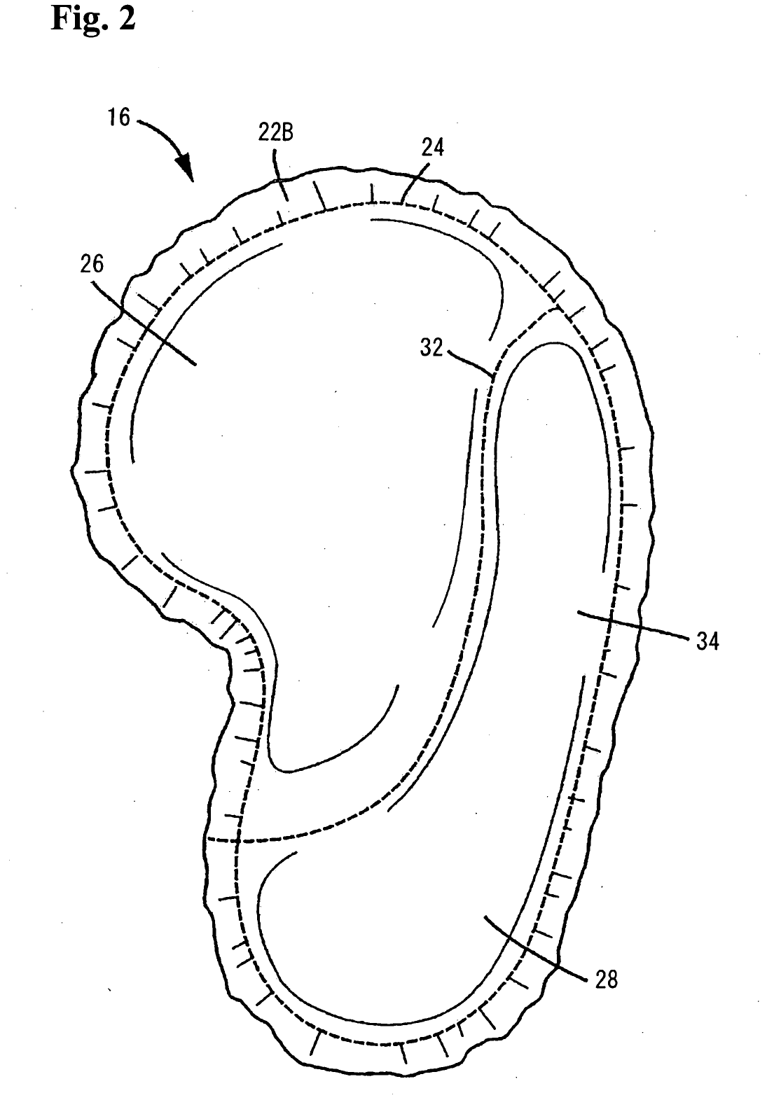

FIG. 2 is a side view showing the overall configuration of the side airbag 16 in an inflated and deployed state.

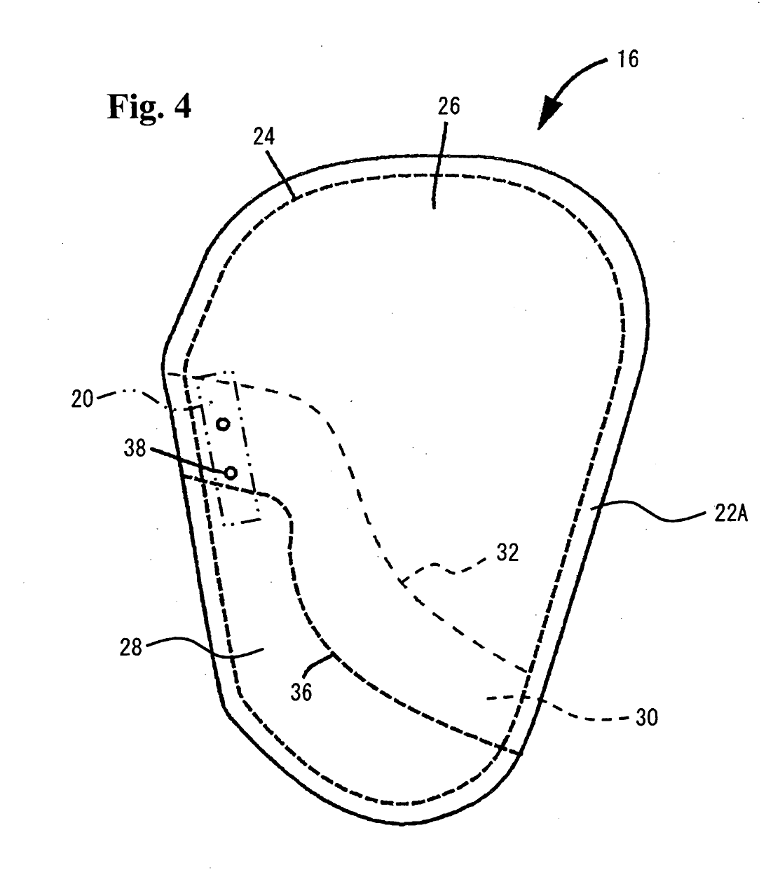

In FIG. 2, the side airbag 16 is shaped like a bag by sewing and connecting a first panel 22A (see below-mentioned FIG. 4) and a second panel 22B having almost the same shape along outer edges thereof. In the figure, reference numeral 24 denotes a sewn and connected portion at the outer edges. The first panel 22A is located to face the occupant 12 to be restrained, and the second panel 22B is located to face a side opposite the occupant 12 (that is, the side wall of the body of the automobile). Since FIG. 2 is a side view, as viewed from the side opposite the occupant 12 (from the side wall of the body of the automobile), it shows only the second panel 22B.

In the above, the first panel 22A forms the first panel portion described in the claims, and the second panel 22B forms the second panel portion.

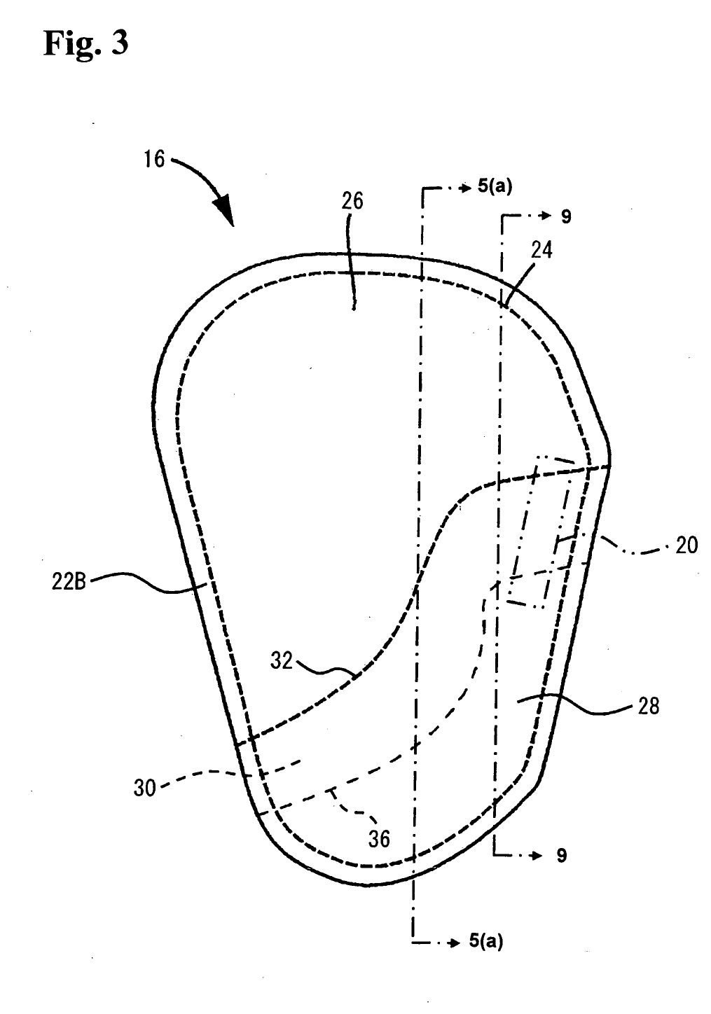

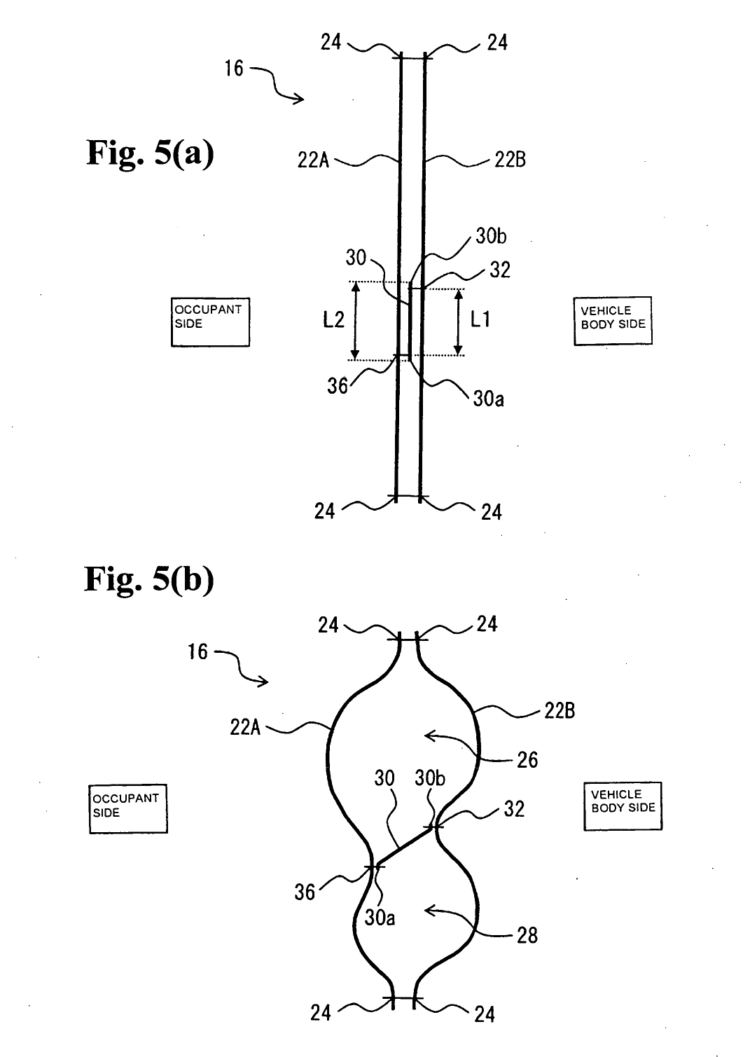

The side airbag 16 is a two-chamber airbag including an upper chamber 26 for receiving the shoulder 12A and the breast 12B (including the abdomen) of the occupant 12 and a lower chamber 28 for receiving the hip 12C of the occupant 12. The upper chamber 26 and the lower chamber 28 are separated by a first tether 30 (see below-mentioned FIGS. 3 to 5(b)) in the side airbag 16. The first tether 30 includes a first edge portion 30a (see below-mentioned FIG. 5(b)) connected to the first panel 22A, and a second edge portion 30b (see below-mentioned FIG. 5(b)) connected to the second panel 22B. In the figure, reference numeral 32 denotes a sewn and connected portion of the second edge portion 30b to the second panel 22B.

The lower chamber 28 includes a cylindrical inflating portion 34 located on the rear side in the vehicle front-rear direction (right side in FIG. 2) and formed by the first tether so as to become substantially cylindrical when inflated. As shown in FIG. 1(b), the cylindrical inflating portion 34 extends substantially along the seat back 10B of the seat 10. The cylindrical inflating portion 34 can increase the rigidity of the lower chamber 28 and can improve the self-standing property of the lower chamber 28. As a result, it is possible to suppress rattling of the lower chamber 28 during inflation and deployment and to thereby enhance deployment stability of the side airbag 16.

FIG. 3 is a plan view of the side airbag 16 in an uninflated state, as viewed from the second panel 22B, FIG. 4 is a plan view of the side airbag 16 in the uninflated state, as viewed from the first panel 22A, FIG. 5(a) is a schematic cross-sectional view of the side airbag 16, taken along line 5(a)-5(a) of FIG. 3, and FIG. 5(b) shows an inflated state of the side airbag 16.

In FIGS. 3 to 5(b), the side airbag 16 includes the upper chamber 26 and the lower chamber 28 separated by the first tether 30, as described above. The first tether 30 is a belt-shaped foundation cloth formed of a material similar to the material of the first panel 22A and the second panel 22B, and has, at both widthwise ends, the first edge portion 30a (see FIGS. 5(a) and 5(b)) connected to the first panel 22A and the second edge portion 30b (see FIGS. 5(a) and 5(b)) connected to the second panel 22B. In the figures, reference numeral 32 denotes the sewn and connected portion of the second edge portion 30b to the second panel 22B, as described above, and reference numeral 36 denotes a sewn and connected portion of the first edge portion 30a and the first panel 22A.

As shown in FIGS. 3 and 4, these sewn and connected portions 32 and 36 are provided in the panels 22B and 22A in a manner such as to be substantially S-shaped (or substantially L-shaped) in a side view of the airbag, in order to form the cylindrical inflating portion 34 on the rear side in the vehicle front-rear direction in the lower chamber 28. Similarly, as shown in FIGS. 3 and 4, the first tether 30 needs to be located in a substantially S-shape (or substantially L-shape) in the side view of the airbag, in order to form the cylindrical inflating portion 34 on the rear side in the vehicle front-rear direction in the lower chamber 28. Moreover, to offset both edge portions 30a and 30b in the up-down direction, the first tether 30 is substantially S-shaped (or substantially L-shaped) in a plan view.

The first tether 30 is sewn and connected to the first panel 22A and the second panel 22B in an offset manner such that the position of the sewn and connected portion 36 (hereinafter simply referred to as a “connected position 36”) serving as a connected position of the first edge portion 30a to the first panel 22A is lower than the position of the sewn and connected portion 32 (hereinafter simply referred to as a “connected position 32”) serving as a connected position of the second edge portion 30b to the second panel 22B. As shown in FIG. 5(a), an offset amount L1 between the connected position 36 of the first edge portion 30a and the connected position 32 of the second edge portion 30b is substantially equal to a width L2 of the first tether 30.

On the rear side in the vehicle front-rear direction in the side airbag 16 (right side of FIG. 3, left side of FIG. 4), the inflator 20 is provided to supply gas for inflating and deploying the side airbag 16 (shown by a two-dot chain line in

FIGS. 3 and 4). While details will be described below, the inflator 20 is fixed to the casing 18 by two bolts 44 (see below-mentioned FIGS. 8(a)-8(c)). Bolt holes 38 through which the bolts 44 are inserted are provided in the first panel 22A (see FIG. 4).

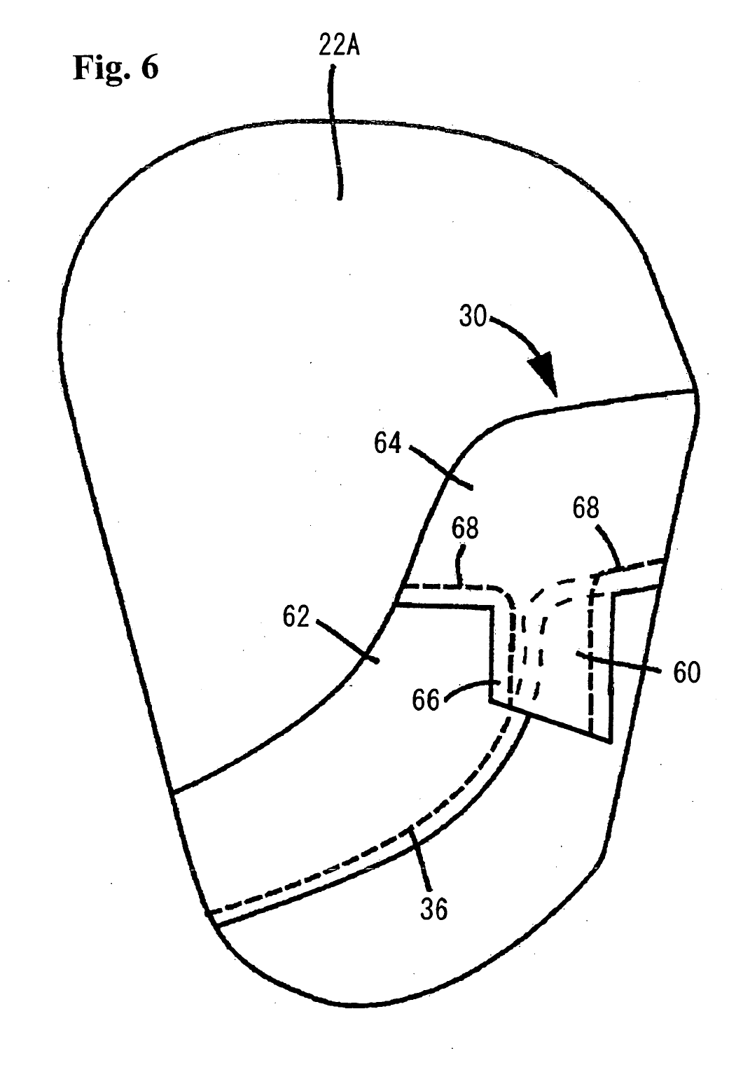

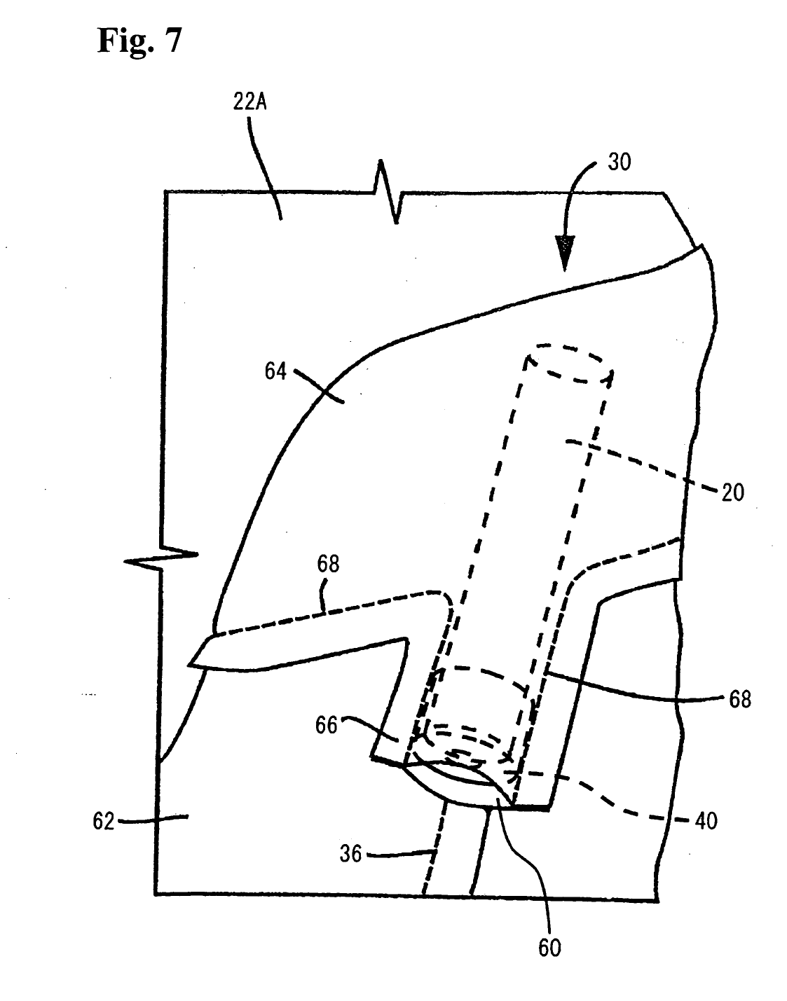

Although not shown in FIGS. 3 to 5(b), since the inflator 20 is located such as to extend through the first tether 30, the first tether 30 has an insertion portion 60 through which the inflator 20 is inserted. Details of the insertion portion 60 will be described with reference to FIGS. 6 and 7.

FIG. 6 is a plan view showing a state in which the first tether 30 is attached to the first panel 22A, in order to show a structure of the insertion portion 60 of the first tether 30. FIG. 7 is an enlarged partial view showing a state in which the inflator 20 is inserted in the insertion portion 60.

In FIGS. 6 and 7, the first tether 30 is formed by sewing and connecting a first tether panel 62 and a second tether panel 64. More specifically, the first and second tether panels 62 and 64 respectively have tab portions 66 of almost the same shape. By connecting the tab portions 66 by sewn and connected portions 68, the insertion portion 60 in which the inflator 20 is inserted is formed.

FIGS. 8(a)-8(c) include views showing a procedure for forming the first tether 30.

As shown in FIG. 8(a), the first tether panel 62 is a foundation cloth substantially shaped like an arc as a whole, and has the above-described tab portion 66 at one end thereof. The second tether panel 64 is a foundation cloth substantially shaped like a triangle as a whole, and has the tab portion 66 having almost the same shape as that of the above-described tab portion 66. The first tether panel 62 is placed on the second tether panel 64 so that the tab portions 66 substantially coincide with each other.

Next, as shown in FIG. 8(b), the tab portions 66 laminated together are connected by the sewn and connected portions 68 so as to form the bag-shaped insertion portion 60 in which the inflator 20 is inserted. After that, as shown in FIG. 8(c), the second tether panel 64 is folded back so that the formed insertion portion 60 faces down, thereby forming the first tether 30 that is substantially S-shaped (or substantially L-shaped) in plan view and that has the insertion portion 60, in which the inflator 20 is inserted, in the lower region in the offset structure thereof.

As described above, a portion of the first tether 30 that separates the upper chamber 26 and the lower chamber 28 is formed by only one panel, that is, the first tether panel 62, thereby reducing the amount of foundation cloth and the thickness of the airbag. On the other hand, since the insertion portion 60 in which the inflator 20 is inserted needs to be bag-shaped, it is formed by two panels, namely, the first and second tether panels 62 and 64.

The first tether 30 having the above structure serves to separate the upper chamber 26 and the lower chamber 28 and to limit the thickness of the side airbag 16 to a predetermined thickness. Further, the first tether 30 also functions as a diffuser that receives the inflator 20 by the insertion portion 60 and rectifies discharged gas in cooperation with a sleeve 40 that will be described below. Since the insertion portion 60 is formed rather long by forming the tab portions 66 rather long, the first tether 30 can have a function (function as a check valve) of preventing gas from flowing back from the lower chamber 28 on the high pressure side to the upper chamber 26 on the low pressure side during inflation of the airbag.

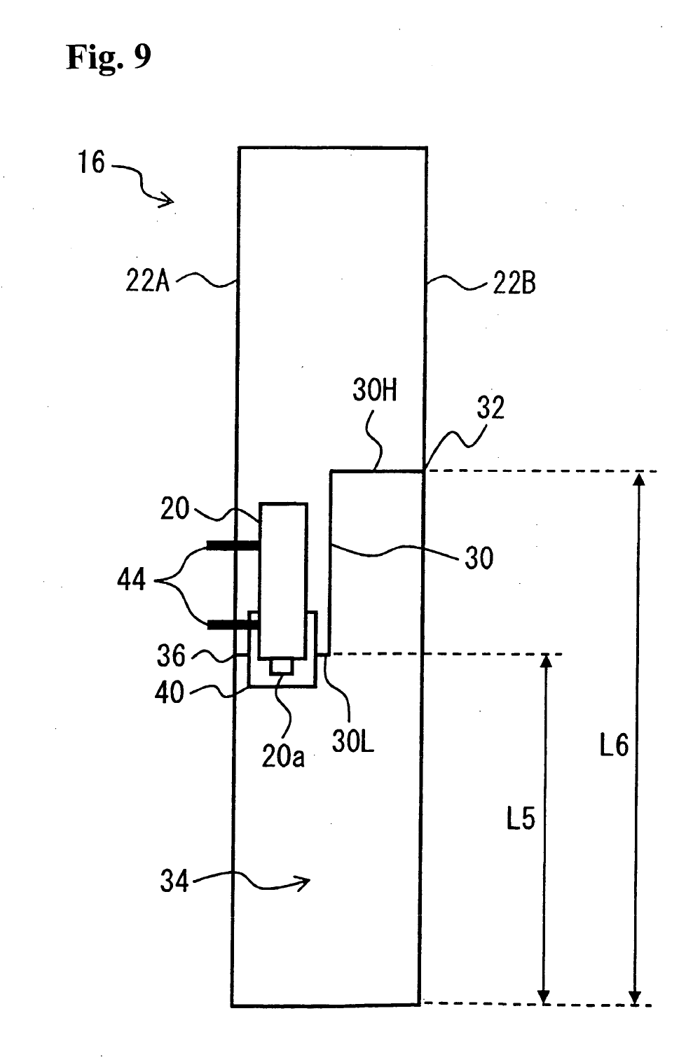

FIG. 9 is a conceptual cross-sectional view of the side airbag 16 in an inflated state (corresponding to a cross section taken along line 9-9 of FIG. 3) explaining that the above-described insertion portion 60 of the first tether 30 allows the inflator 20 to be inserted in the lower region of the first tether 30.

In FIG. 9, as described above, the first tether 30 is connected to the first and second panels 22A and 22B in an offset manner such that the connected position 36 to the first panel 22A is lower than the connected position 32 to the second panel 22B. As a result, when the side airbag 16 is inflated, a higher region 30H close to the second panel 22B and a lower region 30L close to the first panel 22A are formed in the first tether 30. By virtue of the above-described structure of the first tether 30, the inflator 20 is inserted together with the sleeve 40 by the insertion portion 60 in the lower region 30L of the first tether 30. To avoid complication, the insertion portion 60 is not shown in FIG. 9.

Hence, if the first tether 30 is not offset, the length in the up-down direction of the cylindrical inflating portion 34 provided on the rear side in the lower chamber 28 is substantially equal to a length L5 from the lower end of the airbag to a portion adjacent a protruding portion 20a of the inflator 20 having gas discharging holes. In contrast, in this embodiment, the length in the up-down direction of the cylindrical inflating portion 34 can be increased from the above length L5 to L6 by the higher region 30H of the first tether 30.

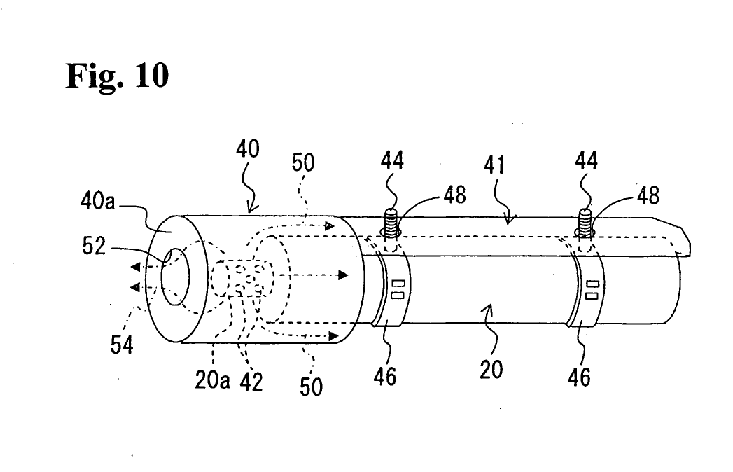

As described above, the gas discharging side of the inflator 20 is fitted together with the sleeve 40 into the insertion portion 60. The sleeve 40 is a cylindrical member having a narrow portion at its tip, and has a flow-rate distributing function of distributing gas discharged from the inflator 20 to the upper chamber 26 and the lower chamber 28 at a predetermined flow-rate ratio. Details of the sleeve 40 will be described with reference to FIG. 10.

FIG. 10 is a perspective view showing an overall structure of the sleeve 40 provided in the inflator 20.

In FIG. 10, the sleeve 40 is a cylindrical member having a narrow portion 40a at an end on one side (left side of FIG. 10) and a tongue portion 41, which allows the sleeve 40 to be retained by the inflator 20, on the other side (right side of FIG. 10). On the other hand, the inflator 20 has a protruding portion 20a on one side (left side of FIG. 10). The protruding portion 20a is provided with a plurality of discharging holes 42 from which gas is discharged. The inflator 20 is supported by clips 46 having the above-described bolts 44. The inflator 20 is fixed to the casing 18 by fastening the bolts 44 to the casing 18.

The tongue portion 41 of the sleeve 40 has holes 48 in which the bolts 44 of the clips 46 provided at two positions in the axial direction of the inflator 20 are inserted. The bolts 44 are inserted in these holes 48, so that the sleeve 40 is engaged with the inflator 20 while covering one side (left side of FIG. 10) of the inflator 20. The inner diameter of the sleeve 40 is larger by a predetermined amount than the outer diameter of the inflator 20, whereby a space for channels (shown by arrows 5.0 in the figure) in which discharged gas flows toward the upper chamber 26 is formed between an inner peripheral surface of the sleeve 40 and an outer peripheral surface of the inflator 20.

The narrow portion 40a of the sleeve 40 is an annular member having an aperture 52. The bore diameter of the aperture 52 is set at an appropriate value calculated beforehand so that the internal pressures of the upper chamber 26 and the lower chamber 28 provided in the side airbag 16 become desired values and so that gas discharged from the inflator 20 is distributed at a proper flow ratio. Here, the bore diameter of the aperture 52 is set so that the internal pressure of the lower chamber 28 for receiving the hip 12C of the occupant 12 is higher than the internal pressure of the upper chamber 26 for receiving the shoulder 12A and the breast 12B that are susceptible to external shock. With this, the flow rate of the gas discharged from the inflator 20 is adjusted to the preset flow rate, and the gas is supplied to the lower chamber 28 (channels are shown by arrows 54 in the figure).

From the above, the flow rate of gas supplied from the inflator 20 to the chambers can be adjusted with a simple structure without adopting a complicated structure, for example, in which a flow-rate adjusting cover having discharging holes corresponding to the chambers is provided in the airbag so as to cover the periphery of the inflator 20.

Next, a description will be given of operational advantages obtained by the side airbag 16 having the above-described configuration.

The side airbag 16 is stored in a folded state in the seat back 10B of the seat 10, and is inflated and deployed between the occupant 12 and the side wall of the vehicle by gas discharged from the inflator 20, for example, in case of a side collision of the vehicle or a rollover of the vehicle body. In this case, as described above, the flow rates of gas supplied from the inflator 20 to the chambers are adjusted so that the internal pressure of the upper chamber 26 for receiving the shoulder 12A and the breast 12B of the occupant 12 that are susceptible to external shock is lower than the internal pressure of the lower chamber 28 for receiving the hip 12C.

In the side airbag 16 including the upper chamber 26 and the lower chamber 28, in general, the gas discharging holes 42 of the inflator 20 are located near the rear end in the vehicle front-rear direction of the first tether 30 serving as a line that separates the two chambers 26 and 28. This aims to smoothly supply the gas from the gas discharging holes 42 to the upper chamber 26 and the lower chamber 28. For this reason, if both edges of the first tether 30 are not offset, the length in the up-down direction of the cylindrical inflating portion 34 located on the rear side in the lower chamber 28 is substantially equal to the length L5 from the lower end of the airbag to the portion adjacent the gas discharging holes 42 of the inflator 20 (see FIG. 9).

In this case, in the side airbag 16 of this embodiment, the first tether 30 that separates the upper chamber 26 and the lower chamber 28 is connected in a manner such that the connected position 36 of the first edge portion 30a connected to the first panel 22A and the connected position 32 of the second edge portion 30b connected to the second panel 22B are offset from each other. By thus locating the lower region 30L of the first tether 30 corresponding to the discharging holes 42 of the inflator 20.with such an offset structure of the first tether 30, the length of the cylindrical inflating portion 34 can be increased from the above-described length L5 (length from the lower end of the airbag to the portion adjacent the gas discharging holes 42 of the inflator 20) to L6 by the higher region 30H (see FIG. 9). Hence, rigidity of the lower chamber can be increased by the cylindrical inflating portion 34 having the increased length. As a result, it is possible to suppress rattling of the lower chamber 28 during inflation and deployment because of the difference in internal pressure between the upper chamber 26 and the lower chamber 28, and to thereby enhance deployment stability of the side airbag 16.

According to the side airbag 16 of the embodiment, the following advantages can also be obtained. That is, for example, in a case in which the connected positions of the first edge portion 30a and the second edge portion 30b of the first tether 30 are not offset, when the length of the cylindrical inflating portion 34 is to be increased for stability of the lower chamber 28, the rear end of the first tether 30 needs to be located at a position as high as possible in the airbag. As a result, the inflator 20 also needs to be mounted at a high position. In contrast, when it is impossible to mount the inflator 20 at a high position, in order to conform to the specifications of a seat frame to which the inflator 20 is fixed, the rear end of the first tether 30 needs to be at a low position. As a result, the length of the cylindrical inflating portion 34 is shortened, and stability of the lower chamber 28 is insufficient. Therefore, to stabilize the lower chamber 28, the mounting position of the inflator 20 is limited to the upper part in the airbag.

In contrast, according to the embodiment, since the connected positions 36 and 32 of the first edge portion 30a and the second edge portion 30b of the first tether 30 to the panels 22A and 22B are offset, when the lower region 30L of the first tether 30 is located corresponding to the gas discharging holes 42 of the inflator 20, as described above, a required length of the cylindrical inflating portion 34 can be ensured by the higher region 30H. Thus, even when the mounting position of the inflator 20 is low, the lower chamber 28 can be stabilized. It is therefore possible to increase the flexibility in the mounting position of the inflator 20.

In the embodiment, in particular, the insertion portion 60 in which the inflator 20 that supplies gas for inflating the side airbag 16 is inserted is provided in the lower region 30L of the first tether 30. Hence, the length L5 of the cylindrical inflating portion 34 (length from the lower end of the airbag to the adjacencies of the discharging holes 42 of the inflator 20) provided in the case in which the above-described offset structure is not adopted can be increased to L6 by the higher region 30H of the first tether. 30. The rigidity of the lower chamber 28 can be increased by the cylindrical inflating portion 34 having the increased length. As a result, it is possible to suppress rattling of the lower chamber 28 during inflation and deployment and to enhance deployment stability of the side airbag 16.

In the embodiment, in particular, the first tether 30 is connected to the first and second panels 22A and 22B in a manner such that the connected position 36 of the first edge portion 30a of the first tether 30 to the first panel 22A is lower than the connected position 32 of the second edge portion 30b to the second panel. 22B. In other words, as shown in FIG. 5(a), the first tether 30 is connected to the panels 22A and 22B in a manner such that the connected position 36 close to the occupant 12 is lower than the connected position 32 on the side opposite the occupant (side close to the side wall of the vehicle). With this, the size of the lower chamber 28 on the side of the first panel 22A close to the occupant 12 can be smaller than the size of the lower chamber 28 on the side of the second panel 22B close to the side wall of the vehicle, as shown in FIG. 5(b). Thus, it is possible to prevent the lower chamber 28, which has a pressure higher than that of the upper chamber 26, from contacting the body of the occupant 12 more than necessary, for example, in case of a side collision of the vehicle or a rollover of the vehicle, and to enhance safety of the occupant 12.

In the embodiment, in particular, the offset amount L1 between the connected position 36 of the first edge portion 30a of the first tether 30 and the connected position 32 of the second edge portion 30b is substantially equal to the width L2 of the first tether 30. In this case, as shown in FIGS. 3 to 5(a), when the side airbag 16 in an uninflated state is placed in a planar form such that the first panel 22A and the second panel 22B are piled together in the up-down direction, the first tether 30 can be made planar without forming a fold and a wrinkle. As a result, since the side airbag 16 can be made flat, it can be easily folded for storage, and can be prevented from becoming bulky. Further, when the side airbag 16 is placed in a planar form, the first tether 30 also becomes planar, and it is therefore possible to enhance operability in connecting (sewing) the first tether 30 to the first panel 22A and the second panel 22B during production.

Next, a second embodiment of the present invention will be described with reference to the drawings.

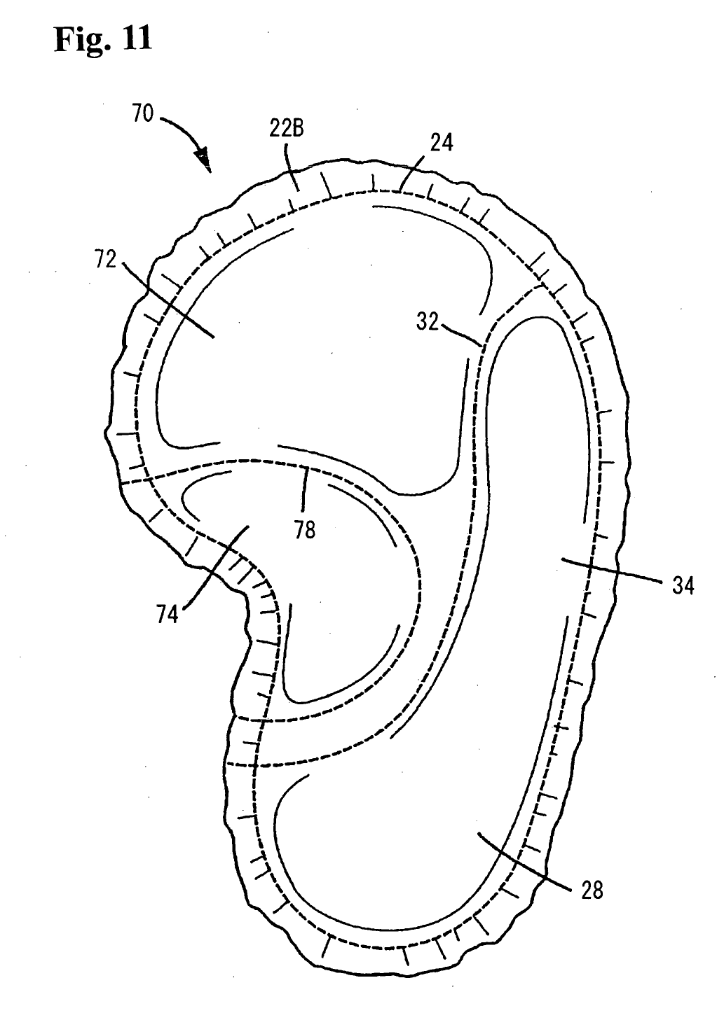

FIG. 11 is a side view showing an overall configuration of a side airbag 70 in an inflated and deployed state according to this embodiment. In FIG. 11, components similar to those shown in the above FIG. 2 are denoted by the same reference numerals, and descriptions thereof are omitted.

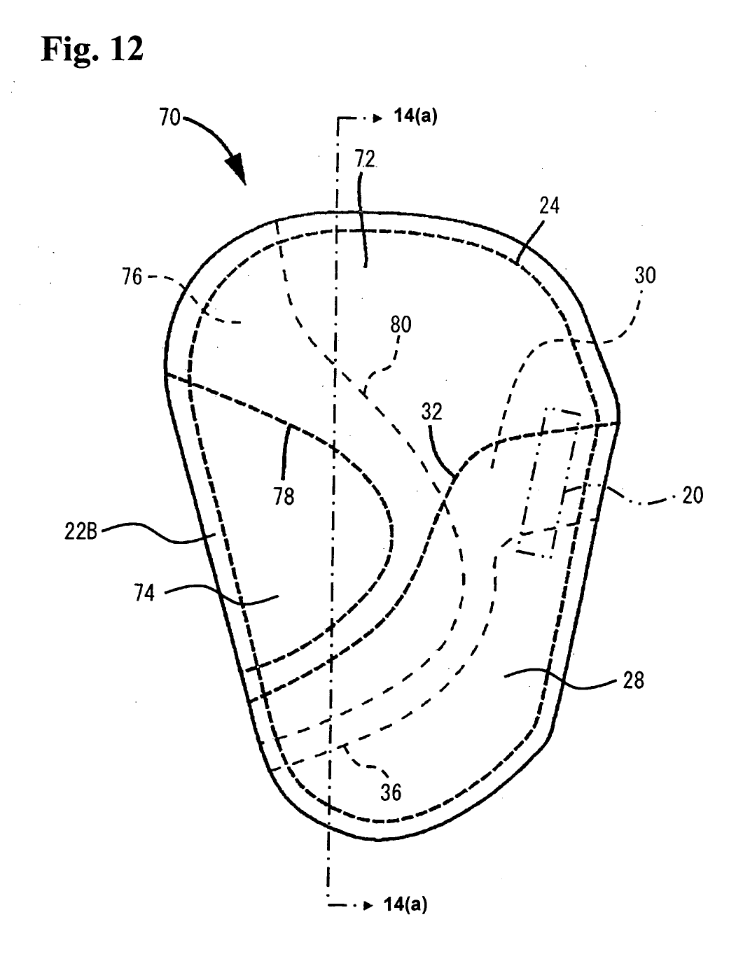

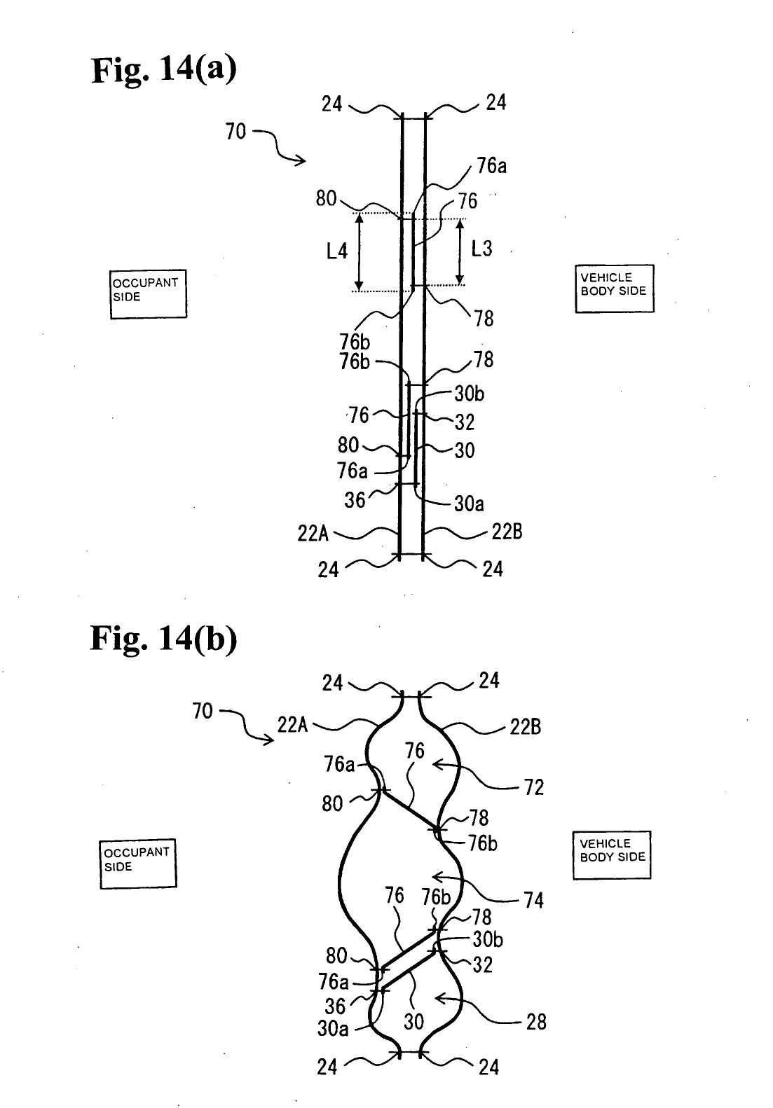

In FIG. 11, the side airbag 70 is a three-chamber airbag including a first chamber 72 for receiving the shoulder 12A of an occupant 12, a second chamber 74 for receiving the breast 12B (including the abdomen) of the occupant 12, and the above-described lower chamber 28 for receiving the hip 12C of the occupant 12. The first chamber 72 and the second chamber 74 are separated by a second tether 76 (see below-mentioned FIGS. 12 to 14(b)) in the side airbag 70. The second tether 76 includes a third edge portion 76a (see below-mentioned FIGS. 14(a) and 14(b)) connected in an arc form to a first panel 22A, and a fourth edge portion 76b (see below-mentioned FIGS. 14(a) and 14(b)) connected in an arc form to a second panel 22B. Reference numeral 78 in the figure denotes a sewn and connected portion of the fourth edge portion 76b to the second panel 22B.

While the second tether 76 is arc-shaped with respect to the panels 22A and 22B as an example in this embodiment, it may have other shapes (e.g., the shape of a straight line).

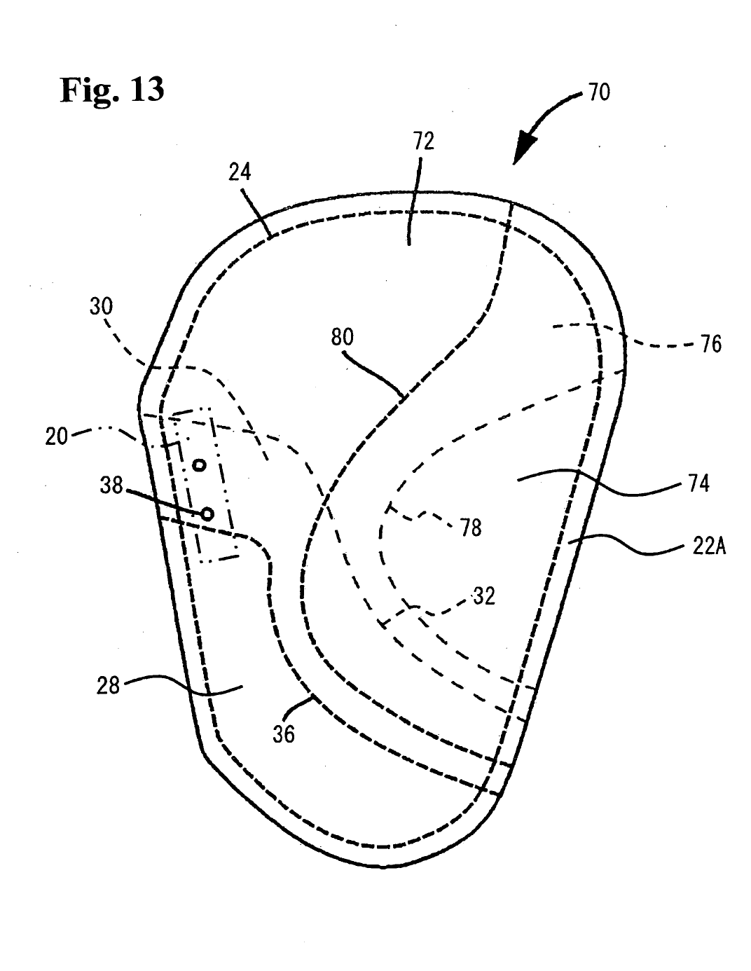

FIG. 12 is a plan view of the side airbag 70 in an uninflated state, as viewed from the second panel 22B, FIG. 13 is a plan view of the side airbag 70 in the uninflated state, as viewed from the first panel 22A, FIG. 14(a) is a schematic cross-sectional view of the side airbag 70, taken along line XIV-XIV of FIG. 12, and FIG. 14(b) is a view showing an inflated state of the side airbag 70. In these figures, components similar to those shown in the above FIGS. 3 to 5 are denoted by the same reference numerals, and descriptions thereof are omitted.

In FIGS. 12 to 14(b), as described above, the side airbag 70 includes the first chamber 72, the second chamber 74, and the lower chamber 28 separated by the second tether 76 and the first tether 30. Similarly to the above-described first tether 30, the second tether 76 is a belt-shaped foundation cloth formed of a material similar to the material of the first panel 22A and the second panel 22B, and has, on both widthwise ends, the third edge portion 76a connected in an arc form to the first panel 22A, and the fourth edge portion 76b (see FIGS. 14(a) and 14(b)) connected in an arc form to the second panel 22B. In the figures, reference numeral 78 denotes the sewn and connected portion of the fourth edge portion 76b to the second panel 22B, as described above, and reference numeral 80 denotes a sewn and connected portion of the third edge portion 76a to the first panel 22A.

The second tether 76 is sewn and connected in an offset manner to the first and second panels 22A and 22B in an airbag upper region (a region substantially higher than the center of the side airbag 70 in the up-down direction) in a manner such that the position of the sewn and connected portion 80 serving as the connected position of the third edge portion 76a to the first panel 22A (hereinafter simply referred to as a “connected position 80”) is higher than the position of the sewn and connected portion 78 serving as a connected position of the fourth edge portion 76b to the second panel 22B (hereinafter simply referred to as a “connected position 78”). As shown in

FIG. 14(a), an offset amount L3 between the connected position 80 of the third edge portion 76a and the connected position 78 of the fourth edge portion 76b is substantially equal to a width L4 of the second tether 76.

In this embodiment, the internal pressure of the first chamber 72 for receiving the shoulder 12A of the occupant 12 is set to be higher than the internal pressure of the second chamber 74 for receiving the breast 12B that is susceptible to external shock. Although not described in detail, this is realized by, for example, providing the second tether 76 with a pressure adjusting valve.

The pressure adjusting valve (not shown) operates also as a path to the second chamber 74, so that the gas supplied from the inflator 20 to the first chamber 72 is supplied to the second chamber 74 through the path (not shown) formed in the second tether 76. Also, the pressure regulation valve and the path may be formed in the first tether 30. Incidentally, the path is formed by, for example, an opening or slit.

Since other structures, such as structures of the first tether 30 and the inflator 20, are similar to those adopted in the above-described first embodiment, descriptions thereof are omitted.

According to the side airbag 70 having the above-described configuration, similarly to the above-described first embodiment, a cylindrical inflating portion 34 can suppress rattling of the lower chamber 28 during inflation and deployment, and this enhances deployment stability of the side airbag 70. Moreover, the following operational advantages can be obtained.

That is, in the embodiment, the side airbag 70 has a three-chamber structure. By thus forming multiple chambers for receiving the parts of the body of the occupant 12, the chambers can perform receiving in fine response to the characteristics of the corresponding body parts. This further enhances safety of the occupant.

In this embodiment, in particular, the second tether 76 is connected to the first and second panels 22A and 22B in the airbag upper region in a manner such that the connected position 80 of the third edge portion 76a of the second tether 76 to the first panel 22A is higher than the connected position 78 of the fourth edge portion 76b to the second panel 22B. Thereby, as shown in FIG. 14(b), the size of the first chamber 72 on the side of the first panel 22A close to the occupant 12 can be made smaller than the size of the first chamber 72 on the side of the second panel 22B close to the side wall of the vehicle. This prevents the first chamber 72, which has a pressure higher than that of the second chamber 74, from contacting the body of the occupant 12 more than necessary, for example, in case of a side collision of the vehicle or a rollover of the vehicle, thereby enhancing safety of the occupant 12.

In the embodiment, in particular, the offset amount L3 between the connected position 80 of the third edge portion 76a of the second tether 76 and the connected position 78 of the fourth edge portion 76b is substantially equal to the width L4 of the second tether 76. Hence, when the side airbag 70 in an uninflated state is placed in a planar form such that one of the first panel 22A and the second panel 22B is placed on the other in the up-down direction, as shown in FIGS. 12 to 14(a), not only the first tether 30, but also the second tether 76 can be made planar without forming a fold and a wrinkle. As a result, even when the side airbag 70 has three chambers, it can be made flat. Therefore, the side airbag 70 can be easily folded for storage and does not become bulky. In addition, it is possible to enhance operability in connecting (sewing) the second tether to the first panel 22A and the second panel 22B during production.

While the present invention is applied to the side airbag device of a so-called seat mount type provided in the seat back 10B of the seat 10 in the above embodiments, for example, the present invention may be applied to a side airbag device of a so-called door mount type provided in the door of the vehicle.

While the side airbag 16 or 70 is shaped like a bag by sewing and connecting the peripheries of the two panels 22A and 22B in the above, for example, it may be shaped by connecting the first panel 22A and the second panel 22B by other connecting means, for example, by hollow weaving. Alternatively, for example, one panel may be folded in half and may be shaped like a bag by connecting peripheral portions other than the folded portion by sewing. The present invention is also applicable to such a side airbag.

While the present invention is applied to the side airbag that inflates and deploys from the seat side face between the body side wall and the occupant 12 (that is, on the collision side of the occupant 12) in the above-described embodiments, the present invention may be applied to a side airbag that inflates and deploys to a side of the occupant opposite the body side wall (that is, a side of the occupant 12 opposite the collision side) so as to restrain the occupant 12 (a so-called far-side airbag).

The disclosure of Japanese Patent Application No. 2009-009320 filed on Jan. 19, 2009 is incorporated as a reference.

While the invention has been explained with reference to the specific embodiments of the invention, the explanation is illustrative and the invention is limited only by the appended claims.

What is claimed is:

1. A side airbag, comprising:
a first panel portion facing an occupant and a second panel portion facing a side opposite the occupant and connected to the first panel portion, to be inflated and deployed on a side of the occupant,
an upper chamber configured to receive at least a breast of the occupant;
a lower chamber configured to receive a hip of the occupant;
a first tether having a first edge portion connected to the first panel portion and a second edge portion connected to the second panel portion, the first tether being connected to separate the upper chamber and the lower chamber such that connected positions of the first edge portion and the second edge portion are offset from each other; and
a cylindrical inflating portion provided on a rear side in the lower chamber in a vehicle front-rear direction, the cylindrical inflating portion being defined by the first tether so as to become cylindrical when inflated.

2. The side airbag according to claim 1, wherein the first tether has a lower region provided with an insertion portion for inserting an inflator that supplies gas for inflating the side airbag.

3. The side airbag according to claim 1, wherein the first tether is connected to the first panel portion and the second panel portion in an offset manner such that the connected position of the first edge portion to the first panel portion is lower than the connected position of the second edge portion to the second panel portion.

4. The side airbag according to claim 1, wherein an offset amount between the connected position of the first edge portion and the connected position of the second edge portion is substantially equal to a width of the first tether.

5. The side airbag according to claim 1, further comprising a second tether configured to separate the upper chamber into a first chamber for receiving the shoulder of the occupant and a second chamber for receiving the breast of the occupant.

6. The side airbag according to claim 5, wherein the second tether includes, a third edge portion connected to the first panel portion and a fourth edge portion connected to the second panel portion, and is connected to the first panel portion and the second panel portion in an offset manner such that a connected position of the third edge portion to the first panel portion is higher than a connected position of the fourth edge portion to the second panel portion at least in a certain region.

7. The side airbag according to claim 5, wherein an offset amount between the connected position of the third edge portion and the connected position of the fourth edge portion is substantially equal to a width of the second tether.

8. A side airbag device comprising:
the side airbag according to claim 1;
an inflator provided on a rear side in the side airbag in the vehicle front-rear direction, the inflator supplying gas for inflating and deploying the side airbag; and
a casing configured to store the side airbag and the inflator.
